(19) United States
(12) Patent Application Publication
(10) Pub. No.: US 2011/0096325 A1
(43) Pub. Date: Apr. 28, 2011

(54) METHOD AND DEVICE FOR THE SPECTROMETRIC MEASUREMENT OF A MATERIAL FLOW MOVING IN THE LONGITUDINAL DIRECTION

(75) Inventors: Andreas Sebold, Weingarten (DE); Dirk Hettwer, Waldbronn (DE); Jens Nolte, Gottingen (DE); Patric Henzi, Karlsruhe (DE)

(73) Assignee: POLYTEC GMBH, Waldbronn (DE)

(21) Appl. No.: 12/906,368

(22) Filed: Oct. 18, 2010

(30) Foreign Application Priority Data
Oct. 22, 2009 (DE) 102009050371.4

(51) Int. Cl. G01J 3/02

(52) U.S. Cl. 356/326

(57) ABSTRACT

A method for the spectrometric measurement of a material flow moving in the longitudinal direction, that includes illumination of an illumination area (1b) on the material flow (10) via an illumination beam (1b) generated in a radiation source (1), at least partial collection of the radiation reflected in a measurement area (2b) on the material flow (10) via optical components and forwarding it to a spectrometer. The illumination area (1b) essentially overlaps the measurement area (2b) and the illumination and measurement areas are stationary in the longitudinal direction. Spectrometric analysis of the radiation guided to the spectrometer is carried out. By rotation of a rotating element (4), both the illumination area and also the measurement area (1b, 2b) are displaced simultaneously along a specified section extending perpendicular to the longitudinal direction, and at least the measurement area (2b) is forwarded to the spectrometer by an optical deflection element (4a) that is arranged on the rotating element (4) and between the measurement area and spectrometer in the beam path of a measurement beam (2a). The radiation source (1) and spectrometer are stationary at least in terms of translating motion in the longitudinal and transverse directions. A device for the spectrometric measurement is also provided.

### CROSS-REFERENCE TO RELATED APPLICATIONS

This application claims the benefit of German Patent Application 10 2009 050 371.4, filed Oct. 22, 2009, which is incorporated herein by reference as if fully set forth.

### BACKGROUND

The invention relates to a method and to a device for the spectrometric measurement of a material flow moving in the longitudinal direction.

In industry and research, spectroscopy offers the ability to carry out quick, reliable, and non-destructive measurements for determining chemical composition, identity control, or layer-thickness determination without expensive sample preparations. In the scope of quality assurance, spectroscopy is used to monitor the defined specifications of the end product during the production process and to optimize processes and products. With this method, product functionality can be determined both qualitatively and also quantitatively, wherein measurements are possible on materials in solid, liquid, or gas phase.

There are various fields of application of spectroscopy for process control and laboratory analysis, such as, e.g., in the pulp and paper industry, for online monitoring of moisture, identification of types of plastic in sorting and recycling plants, monitoring food quality in production, etc.

Measurements can be differentiated into transmission and reflection arrangements, wherein the present invention relates to reflection arrangements. Here, in known devices, a spectrometer is arranged in the direct vicinity of the material flow. Furthermore, through the use of a light source, an illumination area on the material flow is illuminated and a measurement area on the material flow that is typically identical with the illumination area collects the reflected radiation using optical components and leads it to the spectrometer. A spectrometric analysis of the reflected radiation is carried out by the spectrometer.

The material flow moving in the longitudinal direction can assume different shapes corresponding to the field of use: for example, the material flow could involve a material web, such as a paper web. Likewise, the use for measurement of bulk material moving on a conveyor belt in the longitudinal direction or web material transported in the longitudinal direction is also possible. Furthermore, the material flow could also be realized as fluid flowing in the longitudinal direction in a fluid flow, in particular, as an opaque fluid.

For the spectral measurement of the material flow, a spatially resolved measurement is performed perpendicular to the material flow, typically on the entire width of the flow.

For the spectrometric measurement of a material flow moving in the longitudinal direction, devices are known that have several pairs of light sources and probes, wherein the pairs are arranged perpendicular to the longitudinal direction. Thus, in DE 198 57 896 C1 a device for the spectrometric measurement of a material flow moving in the longitudinal direction is described in which several light sources and probes allocated to each light source are arranged in the transverse direction. The spatially resolved measurement in the transverse direction is thus achieved such that, for multiple location points, a measurement is performed by a spectrometer perpendicular to the longitudinal direction.

In the same publication, another known embodiment of a device for the spectrometric measurement of a material flow moving in the longitudinal direction is described in which a measurement head with a radiation source and a probe traverses perpendicular to the material flow. The spatially resolved measurement is thus achieved by traversing of the measurement head and time-successive measurement processes.

Furthermore, in devices with traversing measurement heads it is known for the spectrometer to have a stationary arrangement and to be connected to the traversing measurement head by a flexible optical waveguide, so that the reflected radiation of the measurement area is guided to the spectrometer by the optical waveguide end arranged in the traversing measurement head.

A disadvantage in the previously described devices is that either several radiation sources and a spectrometer or a mechanical device for traversing of the measurement head are required. This leads to a cost-intensive construction. For the previously known devices that have an optical waveguide, there is also the risk of breakage due to the mechanical load on the optical waveguide.

Furthermore, devices are known in which the material flow is illuminated over the entire width perpendicular to the longitudinal direction and only the measurement head is traversed. This produces the additional disadvantage that a high radiation power is required for illumination of the material flow over the entire width, in order to achieve an adequate, surface-area illumination of the material flow. This leads to a cost-intensive construction of the radiation source.

### SUMMARY

The present invention is therefore based on the objective of providing a method and a device for the spectrometric measurement of a material flow moving in the longitudinal direction, in order to allow a spatially resolved measurement perpendicular to the longitudinal direction with an economical and robust construction that is also not prone to errors.

This objective is met by a method and a measurement device according to the invention. Advantageous constructions of the method are found in the description and claims below.

The method according to the invention for the measurement of a material flow moving in the longitudinal direction comprises the illumination of an illumination area on the material flow by an illumination beam generated by a radiation source, the at least partial collection of the radiation reflected at a measurement area on the material flow by optical components, in particular, a probe, and forwarding to a spectrometer, wherein the illumination area essentially overlaps the measurement area and the illumination and measurement areas are stationary in the longitudinal direction. The method further comprises the spectrometric analysis of the radiation led to the spectrometer.

It is essential that both the illumination and also measurement areas are displaced simultaneously along a specified section extending perpendicular to the longitudinal direction by the rotation of a rotating element. Here, the radiation reflected on the measurement area is forwarded at least by an optical deflection element arranged on the rotating element—optionally with the intermediate arrangement of additional optical components, wherein the deflection element is arranged in the beam path of a measurement beam between the measurement area and the spectrometer. Furthermore, the radiation source and spectrometer are stationary in the longitudinal and transverse directions at least in terms of translating motion.

The method according to the invention thus differs from the known prior art in that the illumination and measurement areas are moved perpendicular to the longitudinal direction simultaneously by the rotation of a rotating element. Thus there is no translating motion of the radiation source and spectrometer, in particular, there is no traversing of these components perpendicular to the longitudinal direction. Furthermore, only one spectrometer is needed for the analysis of a measurement area and accordingly only one radiation source with which an illumination area essentially overlapping the measurement area is generated. Thus, on one hand, a cost-intensive and error-prone mechanism for traversing any components can be eliminated and also both the radiation source and also the spectrometer can be optimized to the illumination or detection with respect to the extent of the measurement area, so that, in particular, a total-area illumination of the material flow is not required across the entire width.

Furthermore, the moving components could be reduced to the rotation of the rotating element, wherein additional cost savings and protection from errors is achieved. In particular, any problems due to mechanical loading on optical waveguides are excluded.

In the transverse direction, the illumination and measurement areas are displaced simultaneously. In contrast, in the longitudinal direction, the illumination and measurement areas are stationary, i.e., the material flow moves in the longitudinal direction under the illumination and measurement areas.

The deflection element is advantageously constructed as an optical deflection mirror or as an optical deflection prism. In this way it is possible to carry out the method according to the invention in an economical way that is not prone to errors.

Advantageously, in the method according to the invention, the beam path of the illumination beam runs between the radiation source and illumination area via the deflection element. Thus, in this advantageous construction, both the measurement beam and also the illumination beam are deflected by the deflection element, so that the illumination and measurement areas are displaced simultaneously perpendicular to the longitudinal direction in an especially simple way by rotation of the rotating element.

In particular, it is advantageous in the preferred embodiment described above for the measurement and illumination beams to overlap in the beam path at least between the deflection element and measurement and illumination areas. The beam path between the deflection element and measurement and illumination areas is thus identical in this advantageous embodiment for the measurement and illumination beams. The superposition is performed by a beam splitter arranged in the beam path of the measurement beam between the spectrometer and deflection element as well as in the beam path of the illumination beam between the radiation source and deflection element.

In this advantageous construction, due to the identical beam path of the measurement and illumination beams between the deflection element and the measurement and illumination areas, a simple adjustment of the optical components is possible.

In another advantageous embodiment of the method according to the invention, the illumination beam is guided starting from the radiation source via a deflection element arranged on the rotating element.

The second deflection element is thus arranged in the beam path of the illumination beam between the radiation source and illumination area.

This embodiment has the advantage that the first deflection element could be optimized for the measurement beam and the second deflection element could be optimized for the illumination beam. In addition, no beam splitter is necessary. Typically, beam splitters represent cost-intensive components relative to deflection elements, so that further cost reduction is achieved in this advantageous embodiment.

Here, the second deflection element is advantageously constructed as an optical deflection mirror or as an optical deflection prism.

Advantageously, for the method according to the invention, the illumination beam runs between the radiation source and deflection element and/or the measurement beam runs between the spectrometer and deflection element at least in the area directly in front of the corresponding deflection element at an angle less than 15°, advantageously at an angle less than 10°, in particular, parallel to the axis of rotation of the rotating element. In this way, a distance-and-rotation-invariant superposition of the measurement and illumination areas is achieved. In particular, a simple optical geometry is achieved such that the illumination beam and/or the measurement beam runs between the radiation source and deflection element at least in the area directly in front of the corresponding deflection element parallel to the axis of rotation of the rotating element.

In another advantageous construction of the method according to the invention, the displacement of the illumination area is achieved in that the radiation source is arranged on the rotating element or the radiation source has a flexible radiation conductor that is connected, on one hand, to a radiation outlet of the radiation source and is arranged, on the other hand, on the rotating element.

Thus, in this advantageous embodiment, for carrying out the method, a second deflection element can be eliminated and the simultaneous displacement of the measurement and illumination area is guaranteed by the arrangement of the radiation source on the rotating element or arrangement of one end of the optical waveguide on the rotating element. In particular, through the arrangement of the radiation source on the rotating element, an economical and robust construction is achieved.

For achieving optimum measurement results it is advantageous that the illumination area completely covers the measurement area. For the cost-saving construction of the method according to the invention, it is advantageous, in particular, that the illumination and measurement areas are identical, so that no area of the material flow is charged with radiation whose reflected radiation is not led to the spectrometer.

The invention further relates to a measuring device for the spectrometric measurement of a material flow moving in the longitudinal direction, wherein the measurement is performed by the method according to the invention. The measuring device comprises a spectrometer and a radiation source for charging an illumination area on the material flow with an illumination beam generated by the radiation source. The radiation source, spectrometer, and optionally additional optical components are constructed and arranged such that a measurement area on the material flow can be imaged on the spectrometer, i.e., the radiation reflected at a measurement area (2b) on the material flow (10) can be guided by optical components at least partially to a spectrometer, and the illumination area essentially covers the measurement area. The measurement and illumination areas are here stationary in the longitudinal direction. The spectrometer is constructed for the spectrometric analysis of the radiation guided onto the spectrometer and reflected on the measurement area.

It is essential that the measuring device comprises at least one drive unit and at least one rotating element that can be rotated by the drive unit. The rotating element has at least one optical deflection element that is arranged in the beam path of a measurement beam between the measurement area and spectrometer such that, through rotation of the rotating element by the drive element, the measurement area can be displaced on the material flow selectively across a specified section perpendicular to the direction of movement of the material flow. Furthermore, the rotating element and radiation source have an interacting construction such that, through rotation of the rotating element, the measurement area and illumination area can be displaced simultaneously on the material flow transverse to the longitudinal direction and here the illumination area essentially covers the measurement area. The spectrometer and radiation source are here arranged stationary in terms of at least translating motion in the longitudinal and transverse directions.

The deflection element is advantageously constructed as an optical deflection mirror or as an optical deflection prism.

Advantageously, the deflection element is arranged in the beam path of the measurement beam and the illumination beam, so that the measurement and illumination areas can be displaced simultaneously through rotation of the deflection element by the rotating element.

In particular, it is advantageous to arrange a beam splitter in the beam path of the measurement beam between the spectrometer and deflection element as well as in the beam path of the illumination beam between the radiation source and deflection element such that the measurement and illumination beams are superimposed in the beam path between the beam splitter, deflection element, and measurement and illumination areas.

In another advantageous construction of the device according to the invention, the radiation source is arranged on the rotating element or the radiation source has a flexible radiation conductor that is connected, on one hand, to a radiation outlet of the radiation source and is arranged, on the other hand, on the rotating element.

In another advantageous construction of the device according to the invention, the rotating element also comprises a second deflection element that is arranged in the beam path of the illumination beam between the radiation source and illumination area. Rotation of the rotating element by the drive unit thus leads simultaneously to rotation of the first and second deflection elements, so that a simultaneous displacement of the measurement and illumination areas is realized.

The second deflection element is constructed advantageously as an optical deflection mirror or as an optical deflection prism.

For the method according to the invention and the device according to the invention, the spatially resolved, spectral measurement of the material flow is thus realized such that the illumination and measurement areas are displaced simultaneously perpendicular to the longitudinal direction, wherein time-successive measurements are performed. Thus, the material flow is scanned or sampled, wherein due to the material flow moving in the longitudinal direction and the illumination and measurement areas that are stationary in the longitudinal direction, the time-successive measurements are performed advantageously on spatial points of the material flow spaced apart from each other both in the longitudinal direction and also the transverse direction.

Advantageously, for the device according to the invention, all of the components are arranged in an open or closed housing. This realizes a construction that is protected from contamination. In particular, a closed housing in which the radiation enters and exits through one or more windows, offers effective protection against contamination.

Advantageously, the displacement of the measurement and illumination areas is realized in the transverse direction exclusively by the rotation of the rotating element, so that a robust and economical construction is achieved, because no other moving parts are required for the mentioned displacement of the measurement and illumination areas. The rotation of the rotating element is performed advantageously about an axis parallel to the longitudinal direction.

In particular, a robust and economical construction is achieved in which the rotating element can rotate exclusively about exactly one specified axis or is rotated about exactly one specified axis.

Typical material flows have a width in the area from 0.1 to 1.5 m. Advantageously, the measurement area comprises a surface area between 0.5 cm² and 30 cm², advantageously between 1 cm² and 10 cm². In particular, the measurement area advantageously has an approximately rectangular, square, elliptical, or circular construction.

The radiation source advantageously generates a wide-band illumination, for example, by means of a halogen lamp. The spectrometric analysis is advantageously performed in the near infrared range, in particular, in the wavelength range of 800 nm to 2500 nm, preferably in the wavelength range of 850 nm to 1650 nm. However, spectrometric analysis in other wavelength ranges likewise lies in the scope of the invention.

Advantageously, the rotation of the rotating element is performed by the back-and-forth oscillation of the rotating element about a specified axis of rotation, in particular, by the back-and-forth oscillation such that the measurement area is displaced across the entire width of the material flow. However, rotation of the rotating element by complete revolutions likewise lies in the scope of the invention.

With respect to the rotating movement of the rotating element, a step-by-step movement of the rotating element is advantageous. Through step-by-step movement, the measurement area thus remains stationary for a specified period of time with respect to displacement in the transverse direction, so that measurements can be performed on this wide position of the material flow across a longer period of time and therefore an average value is formed for each width position, i.e., the corresponding distance to the edge of the material flow. Continuous movement of the rotating element likewise lies in the scope of the invention. In particular, a uniform, continuously repeating displacement of the measurement area from one edge of the material flow to the opposite edge and back allows a good average-value formation of the average measurement data of the material flow with respect to the entire width.

Due to the stationary radiation source and spectrometer at least with respect to translating motion in the transverse direction, for the displacement of the measurement and illumination areas in the transverse direction, the distance of these areas to the spectrometer or to the radiation source changes. Such a change in distance leads to a change in the radiation intensity, because this decreases quadratically with increasing distance. The intensity values measured by the spectrometer thus depend not only on the material properties of the measured material area on the material flow, but instead also on the corresponding distance for the completed measurement.

Therefore, advantageously, instead of the intensity or absorption, the derivative, advantageously the first or second derivative, is evaluated according to the wavelength from the spectra measured by the spectrometer, wherein the effect of a time-varying distance is eliminated. Such a method is known in principle and described, for example, in DE 198 57 896 C1.

Advantageously, the device comprises a probe that is arranged in the beam path of the measurement beam for collecting the radiation reflected on the measurement area. The probe is connected by an optical waveguide to the spectrometer, so that the radiation collected by the probe is incident on the spectrometer via the optical waveguide.

For carrying out the spectrometric analysis, known spectrometers can be used. In particular, known diode line spectrometers are advantageous for the measuring device according to the invention and the measurement method according to the invention, because the fast measurement time of a diode line spectrometer allows fast scanning of the material flow. Typical measurement times here lie in the millisecond range for each spectrum.

For the arrangement of all of the components of the measuring device according to the invention in a housing it is advantageous to provide one or more optically transparent windows through which the illumination beam is discharged and the measurement beam enters into the housing. This prevents contamination of the components located in the housing. Because these windows, however, have different transmission values as a function of the angle of incidence of a beam incident on the window, advantageously the angle-dependent characteristics of the window or windows being used are taken into consideration in the evaluation of the data measured by the spectrometer and the measurement data is corrected accordingly.

Alternatively it is advantageous to construct the window in the form of a partial lateral surface of a cylinder, so that the measurement beam and illumination beam are always incident on the surface of the window in the radial direction. In this way, a different transmission as a function of different angles of incidence is prevented and thus does not have to be taken into consideration for the evaluation of the measurement data.

The drive unit is advantageously is constructed as a stepper motor or rotary magnet. Advantageously the drive unit is connected by a shaft and/or a drive belt, in particular, a toothed belt, to the full load.

The distance between the rotating element and the material flow typically equals between 0.1 m and 3 m, advantageously between 0.2 m and 1.5 m.

The total pivot angle by which the rotating element is pivoted for maximum displacement of the measurement area and/or the illumination area starting from an edge position on the material flow to an opposite edge position equals advantageously between 20° and 80°, in particular, between 50° and 70°, advantageously in approximately 60°.

### BRIEF DESCRIPTION OF THE DRAWINGS

Additional advantageous features and advantageous embodiments of the method according to the invention and the measurement device according to the invention are given from the figures and the following description of the figures.

Shown herein are:

FIG. 1 is a view of a first embodiment of a measuring device according to the invention in which a light source is arranged on a rotating element;

FIG. 2 is a view of a second embodiment of a device according to the invention in which the measurement and illumination beams are guided by a deflection mirror on the rotating element;

FIG. 3 is a view of a third embodiment of a device according to the invention in which the rotating element has two deflection mirrors, and

FIG. 4 is a view of a fourth embodiment of the device according to the invention in which the measurement and illumination beams are superimposed by a beam splitter.

### DETAILED DESCRIPTION OF THE PREFERRED EMBODIMENTS

In all of the figures, a material flow 10 is shown schematically that moves in the longitudinal direction L, i.e., in the plane of the drawing, from the left to the right. Identical reference symbols in all of the figures designate identical or analogous elements.

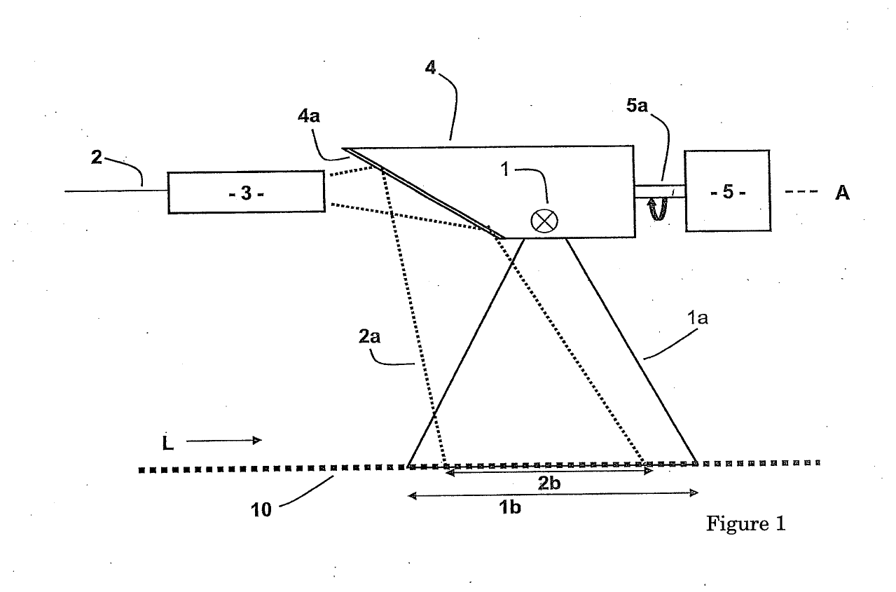

The first embodiment shown in FIG. 1 for a measuring device according to the invention comprises a radiation source 1 constructed as a light source and a (not shown) spectrometer that has a radiation input on which on end of an optical waveguide 2 is attached. With the other end, the optical waveguide 2 is connected in a light-conducting way to a probe 3.

It is essential that the measuring device comprises a rotating element 4 that is connected via a shaft 5a to a drive unit 5 constructed as a stepper motor or as a rotary magnet.

The rotating element 4 has a deflection element that is constructed as a deflection mirror 4a and is arranged tilted relative to an axis of rotation A of the stepper motor and thus also the shaft and the rotating element.

In this embodiment, the radiation source 1 is arranged on the rotating element 4, so that tilting of the rotating element 4 about the axis of rotation A likewise causes a tilting of the illumination beam 1a emitted from the radiation source 1. Through the use of the radiation source 1, an illumination area 1b is charged with radiation on the material flow 10. The radiation reflected from a measurement area 2b on the material flow 10 is deflected in the beam path of a measurement beam 2a via the deflection mirror 4a onto the probe 3 that collects the radiation and forwards it to the spectrometer via the optical waveguide 2.

Through the arrangement of the light source 1 and the deflection mirror 4a on the rotating element 4, a rotation of the rotating element 4 about the axis of rotation A causes a simultaneous displacement of the illumination area 1b and measurement area 2b perpendicular to the plane of the drawing in FIG. 1 and thus perpendicular to the longitudinal direction L.

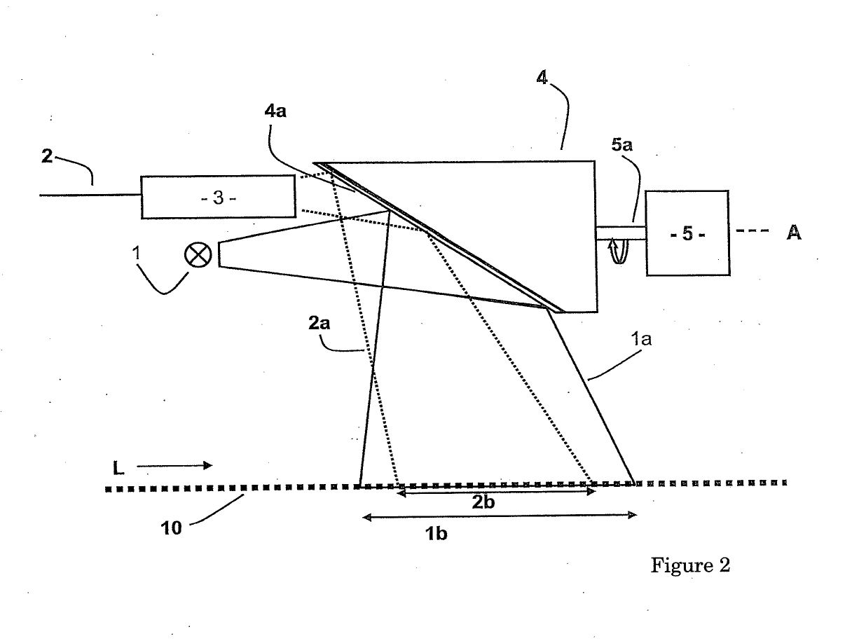

For the second embodiment shown in FIG. 2, both the probe 3 and also the radiation source 1 are arranged fixed in place and the beam paths run from the measurement and illumination beams via the mirror 4a arranged on the rotating element 4.

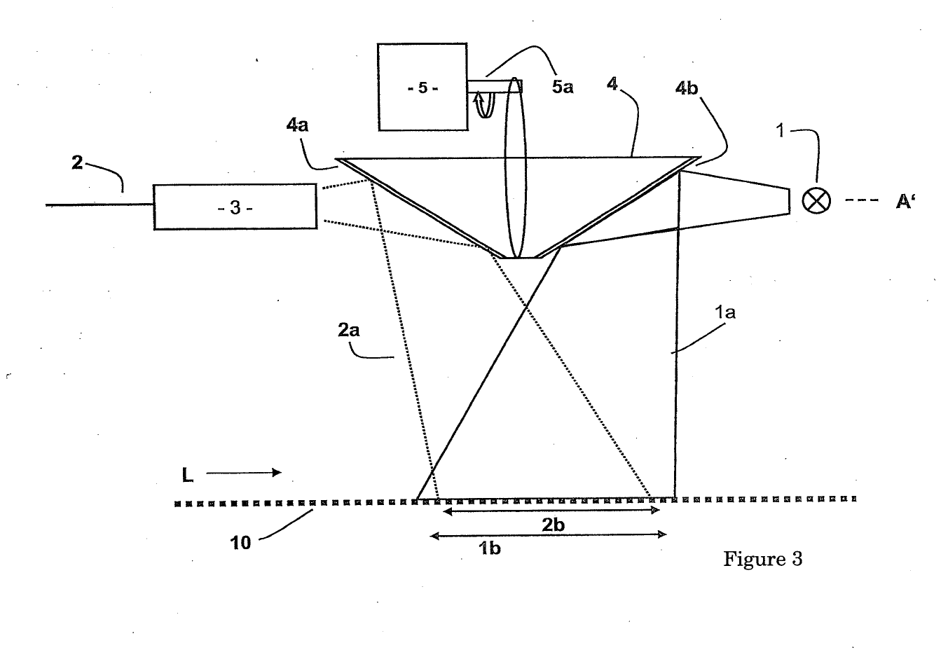

In the embodiment shown in FIG. 3, the light source likewise has an arrangement fixed in place, but on the side of the rotating element 4 opposite the probe 3. The rotating element also has a second deflection element that is constructed as a second deflection mirror 4b and is arranged on the side of the rotating element 4 opposite the probe.

The rotating element is driven by a toothed belt attached to the shaft 5a of the drive unit 5 for rotation about the axis A′.

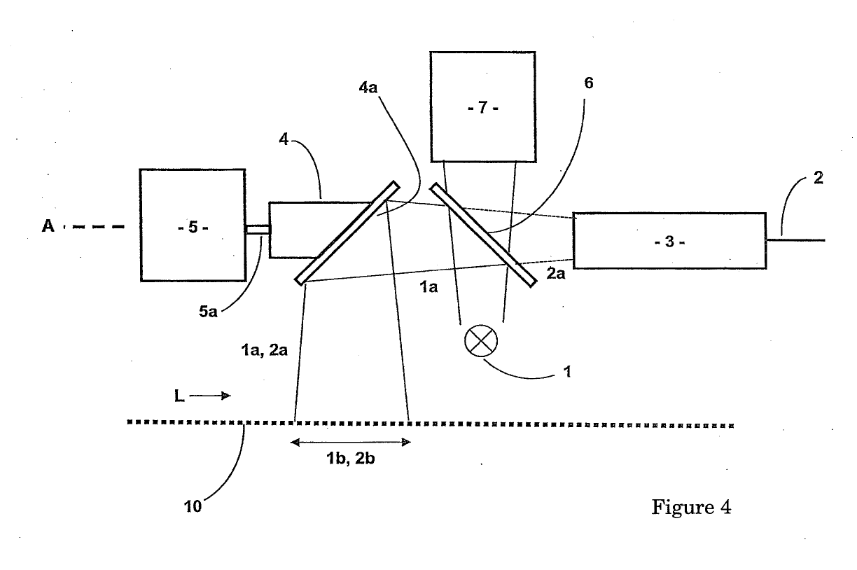

The fourth embodiment shown in FIG. 4 in a device according to the invention differs from the preceding embodiments of the FIGS. 1 to 3 such that measurement and illumination beams are superimposed by a beam splitter 6.

Starting from the radiation source 1, the illumination beam 1a is deflected from the beam splitter 6 onto the deflection mirror 4a of the rotating element 4 and from the deflection mirror 4a onto the illumination area 1b.

For this embodiment, the measurement and illumination areas (1b, 2b) are identical and the radiation reflected from the material flow 10 is deflected by the deflection mirror 4a onto the beam splitter 6. Between the beam splitter 6, deflection mirror 4a, and illumination field or measurement field, the beam paths of the measurement and illumination beams (1a, 2a) are identical. The measurement beam, however, passes through the beam splitter 6 and is incident on the probe 3.

In order to avoid disruptive effects, the fourth embodiment shown in FIG. 4 also comprises a beam trap 7.

All four embodiments described above have in common that the simultaneous movement of the illumination and measurement areas are achieved on the material flow merely through the rotation of the rotating element 4. In this way, a construction of the device according to the invention that is economical and not prone to errors is given.

1. Method for the spectrometric measurement of a material flow moving in a longitudinal direction, comprising the following steps:
illuminating an illumination area (1b) on the material flow (10) with an illumination beam (1b) generated by a radiation source (1),
at least partially collecting radiation reflected from a measurement area (2b) on the material flow (10) using optical components and forwarding the reflected radiation to a spectrometer, wherein the illumination area (1b) essentially overlaps the measurement area (2b) and the illumination and measurement areas are stationary in the longitudinal direction,
conducting a spectrometric analysis of the radiation guided to the spectrometer,
displacing both the illumination area and also the measurement area (1b, 2b) simultaneously along a specified section extending perpendicular to the longitudinal direction by rotating a rotating element (4), and at least the reflected radiation from the measurement area (2b) is forwarded to the spectrometer at least by an optical element (4a) that is arranged on the rotating element (4) and between the measurement area and spectrometer in the beam path of a measurement beam (2a), and
maintaining the radiation source (1) and spectrometer stationary at least in terms of translating motion in the longitudinal and transverse directions.

2. The method according to claim 1, wherein the beam path of the illumination beam (1a) extends between the illumination source (1) and illumination area via the deflection element (4a).

3. The method according to claim 2, wherein the measurement and illumination beams (1a, 2a) are superimposed in the beam path at least between the deflection element (4a) and measurement and illumination areas (1b, 2b), by a beam splitter (6) arranged in the beam path of the measurement beam between the spectrometer and deflection element (4a) as well as in the beam path of the illumination beam between the radiation source (1) and deflection element (4a).

4. The method according to claim 1, wherein the illumination beam (1a) is guided starting from the radiation source (1) via a second deflection element (4b) arranged on the rotating element (4).

5. The method according to claim 4, wherein between the radiation source (1) and deflection element (4a, 4b), the radiation beam (1a), or between the spectrometer and the deflection element, the measurement beam runs at least in an area directly in front of the deflection element at an angle less than 15° or along an axis of rotation (A, A′) of the rotating element.

6. The method according to claim 1, wherein displacement of the illumination area is achieved such that the radiation source (1) is arranged on the rotating element (4) or the radiation source (1) has a flexible radiation conductor that is connected between a radiation outlet of the radiation source (1) and the rotating element (4).

7. The method according to claim 1, wherein between the spectrometer and deflection element (4a), the measurement beam (2a) extends at least in an area directly in front of the deflection element (4a) at an angle less than 15° or along the axis of rotation (A, A′) of the rotating element.

8. The method according to claim 1, wherein the illumination area (1b) completely covers the measurement area (2b).

9. A measuring device for the spectrometric measurement of a material flow moving in a longitudinal direction, comprising a spectrometer and a radiation source (1) for applying an illumination area (1b) on the material flow (10) with an illumination beam (1a) generated by the radiation source (1), the radiation source (1), spectrometer, and optionally additional optical components are constructed and arranged such that radiation that is at least partially reflected from a measurement area (2b) on the material flow (10) can be guided to a spectrometer, the illumination area (1b) essentially overlaps the measurement area (2b), and the measurement and illumination areas are stationary in a longitudinal direction, the measurement device includes at least one drive unit (5) and at least one rotating element (4) that is rotatable by the drive unit, the rotating element (4) has at least one optical deflection element (4a) that is arranged in the beam path of a measurement path (2a) between the measurement area and spectrometer such that, through the rotation of the rotating element (4) by the drive element (5), the measurement area (2b) can be displaced on the material flow (10) selectively across a specified section perpendicular to a direction of movement of the material flow, the rotating element (4) and radiation source (1) have an interacting construction such that, through the rotation of the rotating element, the measurement area (2b) and illumination area (1b) can be displaced simultaneously on the material flow (10) perpendicular to the longitudinal direction, and the spectrometer and radiation source (1) are arranged stationary at least in terms of translating movement in the longitudinal and transverse directions.

10. The device according to claim 9, wherein the deflection element (4a) is arranged in the beam path of the measurement and the illumination beam (1a, 2a).

11. The device according to claim 10, wherein a beam splitter (6) is arranged in the beam path of the measurement beam between the spectrometer and deflection element (4a) and also in the beam path of the illumination beam between the radiation source (1) and deflection element (4a) such that the measurement and illumination beams (1a) are superimposed in the beam path between the beam splitter (6), deflection element (4a), and the measurement and illumination areas (1b, 2b).

12. The device according to claim 9, wherein the radiation source (1) is arranged on the rotating element (4) or the radiation source (1) has a flexible radiation conductor that is connected on one hand to a radiation outlet of the radiation source (1) and is arranged on the other hand on the rotating element (4).

13. The device according to claim 9, wherein the rotating element (4) also has a second deflection element (4b) that is arranged in the beam path of the illumination beam between the radiation source (1) and the illumination area.

14. The device according to claim 13, wherein between the spectrometer and deflection element (4a), the measurement beam (2a) extends at least in the area directly in front of the deflection element (4a) at an angle less than 15° or along an axis of rotation (A, A′) of the rotating element.

15. Device according to claim 14, wherein between the radiation source and deflection element (4a, 4b), the illumination beam (1a) extends at least in the area directly in front of the deflection element at an angle less than 15° or along the axis of rotation (A, A′) of the rotating element.
